(19) United States
(12) Patent Application Publication
(10) Pub. No.: US 2024/0063595 A1
(43) Pub. Date: Feb. 22, 2024

(54) POWER SUPPLY MODULE AND AC ADAPTER

(71) Applicant: RADIUS CO., LTD., Tokyo (JP)

(72) Inventor: Susumu KOHDA, Tokyo (JP)

(73) Assignee: RADIUS CO., LTD., Tokyo (JP)

(21) Appl. No.: 18/500,447

(22) Filed: Nov. 2, 2023

Related U.S. Application Data
(62) Division of application No. 18/550,714, filed on Jan. 1, 0001.

(30) Foreign Application Priority Data
Mar. 16, 2021 (JP) 2021-042788
Jun. 25, 2021 (JP) 2021-106101

(51) Int. Cl. H01R 31/06; H01R 43/20; H02M 7/04; H01R 24/68

(52) U.S. Cl. CPC H01R 31/06; H01R 43/20; H02M 7/04; H01R 24/68

(57) ABSTRACT

In order to reduce the cost of producing AC adapters of a plurality of models, an AC adapter product group is constituted by AC adapters of a plurality of models. An AC adapter of each model includes a power supply module including a plug (11), a pair of electrodes (12) configured to be electrically communicated with the plug (11), and an internal frame (second frame 132) that attaches the plug (11) and the pair of electrodes (12) to a housing (20) and includes the housing (20). The power supply module is common to the plurality of models. The housing (20) is unique to each of the plurality of models.

This application is a divisional of U.S. application Ser. No. 18/550,714, filed Sep. 15, 2023, which is a national phase under 35 U.S.C. § 371 of PCT International Application No. PCT/JP2021/024255 which has an International filing date of Jun. 25, 2021, which claims priority to Japanese Application No. 2021-042788 filed Mar. 16, 2021 and Japanese Application No. 2021-106101 filed Jun. 25, 2021, the entire contents of each of which are hereby incorporated by reference.

### TECHNICAL FIELD

The present invention relates to an AC adapter and a power supply module constituting the AC adapter.

### BACKGROUND ART

Recent years have seen the widespread presence of AC adapters which convert, into DC power, AC power supplied from an electrical outlet that is an output port of a commercial AC power supply and in which a plug to be inserted into the electrical outlet and an AC-DC conversion circuit are stored in a single housing. In such an AC adapter, an output port for outputting DC power is provided in, among the wall surfaces constituting the housing, a wall surface that is different from a wall surface on which the plug is provided.

In many cases, a connector jack of USB Type-A in accordance with the Universal Serial Bus (USB) standard is employed as such an output port. In addition, in recent years, there are cases where a connector jack of USB Type-C is employed. In such a case, the AC-DC conversion circuit is configured to be in accordance with the USB Power Delivery (PD) standard. In addition, the number of output ports included in the AC adapter is not limited to one, and can be two or more. Therefore, output ports that may be included in AC adapters range variously.

### SUMMARY OF INVENTION

### Technical Problem

An aspect of the present invention relates to the aforementioned AC adapter and a power supply module constituting the AC adapter. An object of the aspect of the present invention is to provide an AC adapter capable of storing a plug which can be inserted into an electrical outlet.

### Solution to Problem

A power supply module in accordance with one aspect of the present invention is a power supply module, comprising: a plug, including a pair of a first plug and a second plug which are each a narrow metal plate, the first plug and the second plug having respective one end parts which are able to be inserted into an electrical outlet; a connecting part, provided near respective other end parts of the first plug and the second plug, and connecting the first plug and the second plug while electrically insulating the first plug and the second plug; a first electrode and a second electrode, each configured by a metal plate, and having respective one end parts which are electrically communicated with the respective other end parts of the first plug and the second plug; and a frame, holding the connecting part, the first electrode, and the second electrode, the connecting part being rotatable to switch between a state where the plug is contained in the frame and a state the plug protrudes from the frame, the first electrode and the second electrode each further having, in addition to the respective one end parts, (i) respective other end parts and (ii) respective intermediate parts positioned between the respective one end parts and the respective other end parts, the respective intermediate parts of the first electrode and the second electrode being positioned to be along the plug in the state where the plug is stored in the frame, when switching from the state where the plug protrudes from the frame to the state where the plug is contained in the frame, the connecting part rotating in a direction in which the plug is closer to the respective intermediate parts of the first electrode and the second electrode, the respective one end parts of the first electrode and the second electrode being bended, at interfaces between the respective one end parts and the respective intermediate parts of the first electrode and the second electrode, so as to be closer to the plug.

An AC adapter in accordance with another aspect of the present invention is an AC adapter, comprising: a power supply module as set forth in the one aspect of the present invention; a substrate on which an AC-DC conversion circuit is mounted; an output port for outputting a DC power supplied from the AC/DC conversion circuit; and a housing containing the substrate, the AC-DC conversion circuit, and the output port.

The power supply module in accordance with the one aspect of the present invention is thus suitably usable for the AC adapter.

Advantageous Effects of Invention

With the one aspect of the present invention, it is possible to provide a power supply module capable of storing a plug. Furthermore, with the another aspect of the present invention, it is possible to provide an AC adapter capable of storing a plug which can be inserted into an electrical outlet.

### BRIEF DESCRIPTION OF DRAWINGS

FIG. 1 is a set of a perspective view and an exploded perspective view illustrating an AC adapter in accordance with Embodiment 1 of the present invention.

FIG. 2 is a plan view illustrating a housing included in the AC adapter illustrated in FIG. 1.

FIG. 3 is a plan view illustrating a substrate included in the AC adapter illustrated in FIG. 1.

FIG. 4 is a perspective view illustrating a plug, a pair of electrodes, and a second frame which are included in the AC adapter illustrated in FIG. 1.

FIG. 5 is a perspective view illustrating the pair of electrodes illustrated in FIG. 4.

FIG. 6 is a side view illustrating a first plug constituting the plug illustrated in FIG. 4.

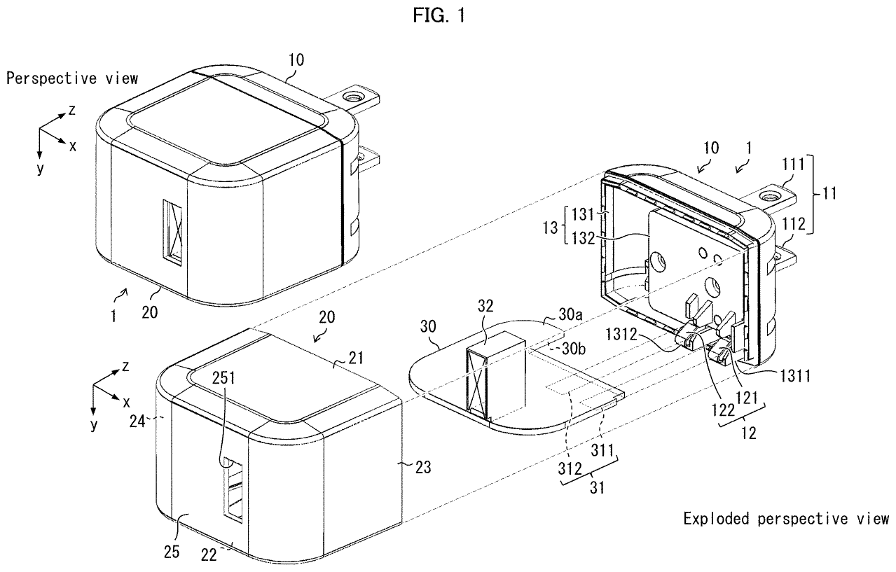

(a) and (b) of FIG. 7 are side views illustrating the second frame included in the AC adapter illustrated in FIG. 1. (c) of FIG. 7 is a side view illustrating the first frame included in the AC adapter illustrated in FIG. 1.

(a) of FIG. 8 is a cross-sectional view illustrating the AC adapter illustrated in FIG. 1. (b) of FIG. 8 is a cross-sectional view illustrating a variation of the AC adapter illustrated in FIG. 1.

(a) through (d) of FIG. 9 are plan views illustrating AC adapters constituting an AC adapter product group in accordance with Embodiment 2 of the present invention. (e) through (h) of FIG. 9 are perspective views illustrating the AC adapters illustrated in (a) through (d) of FIG. 9.

(a) through (c) of FIG. 10 are plan views illustrating other AC adapters constituting the AC adapter product group in accordance with Embodiment 2 of the present invention. (d) through (f) of FIG. 10 are perspective views illustrating the AC adapters illustrated in (a) through (c) of FIG. 10.

### DESCRIPTION OF EMBODIMENTS

### Embodiment 1

[Overview of AC Adapter]

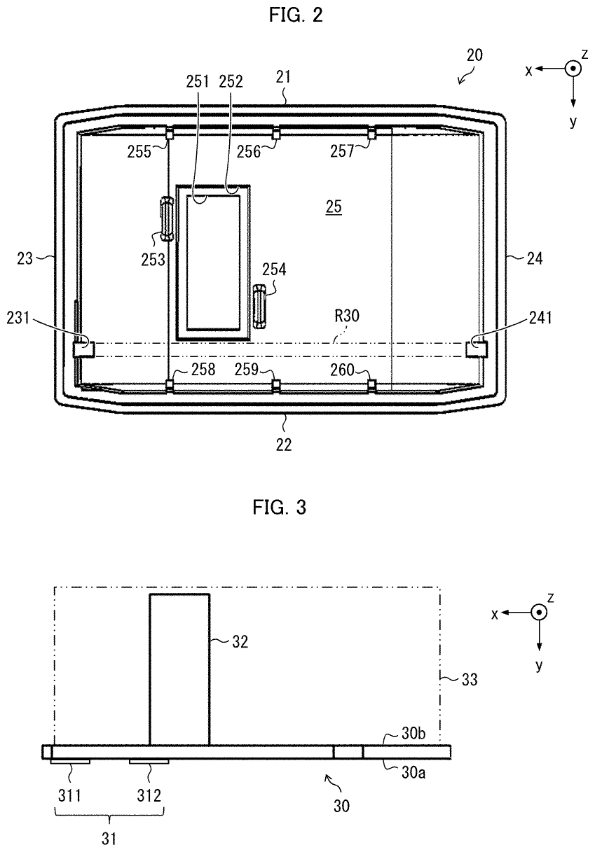

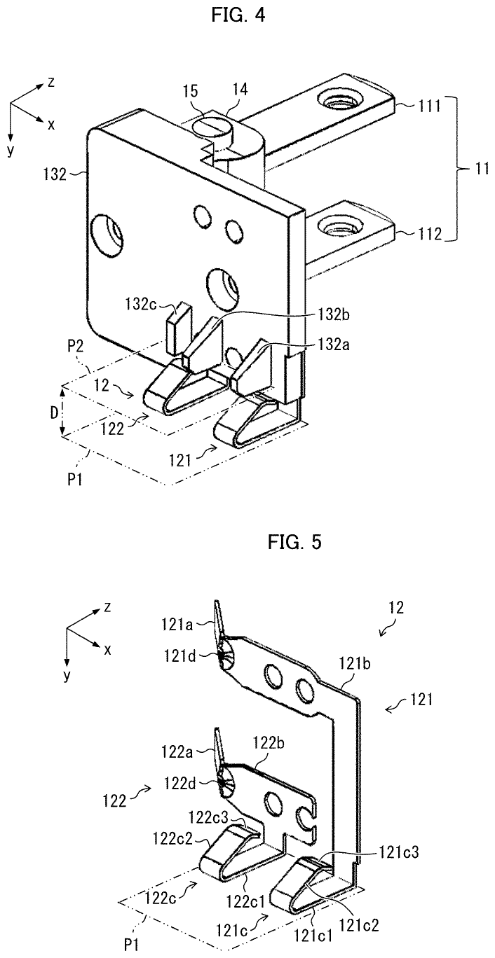

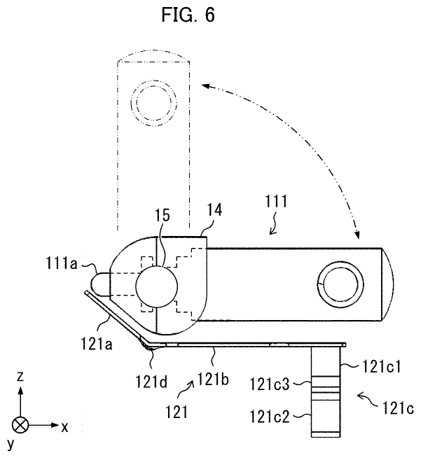

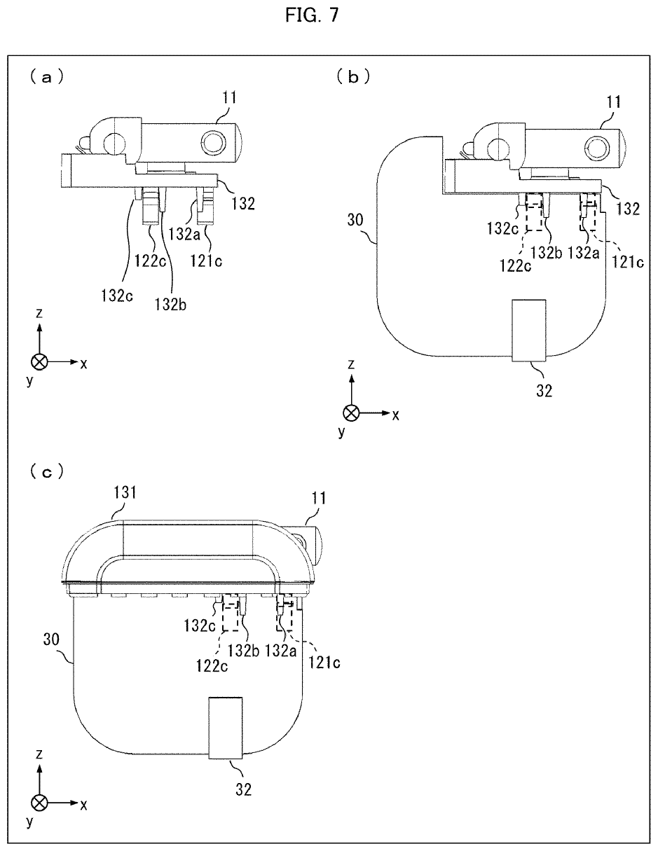

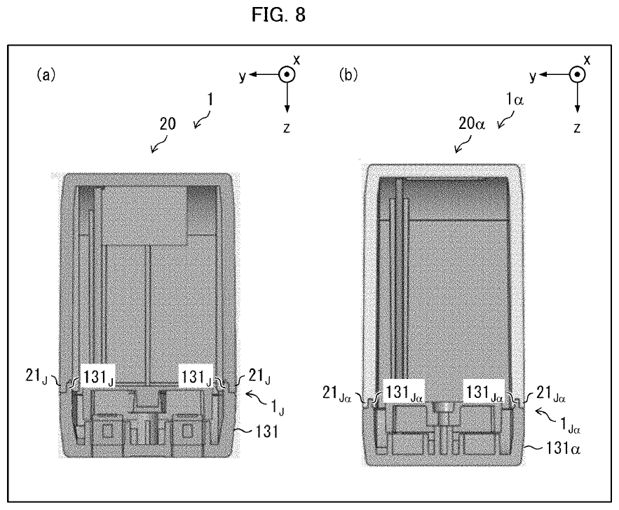

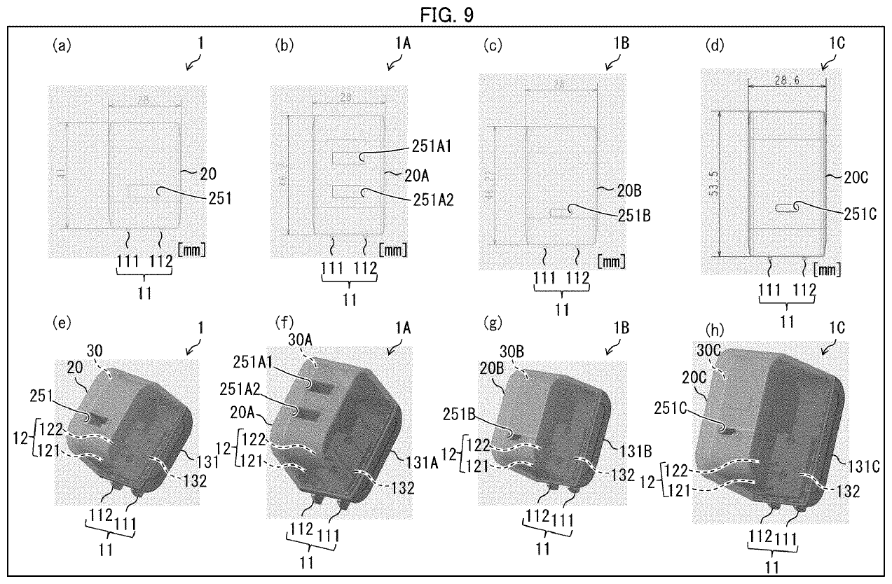

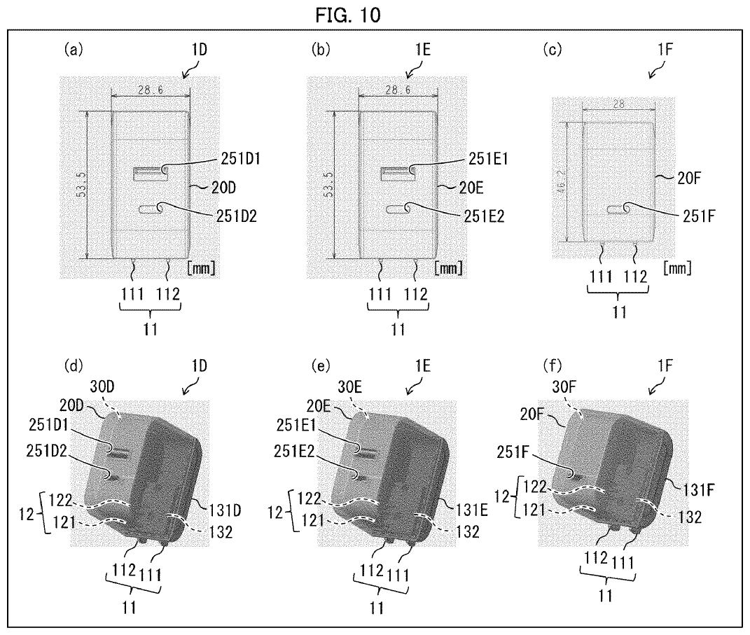

An AC adapter 1 in accordance with Embodiment 1 of the present invention will be described with reference to FIGS. 1 through 6. FIG. 1 is a set of a perspective view and an exploded perspective view illustrating the AC adapter 1. FIG. 2 is a plan view illustrating a housing 20 included in the AC adapter 1. FIG. 3 is a plan view illustrating a substrate 30 included in the AC adapter 1. FIG. 4 is a perspective view illustrating a plug 11, a pair of electrodes 12, and a second frame 132 included in the AC adapter 1. FIG. 5 is a perspective view illustrating the pair of electrodes 12. FIG. 6 is a side view illustrating a first plug 111 constituting the plug 11. In the present embodiment, an orthogonal coordinate system is set so that main surfaces 30a and 30b, which are a pair of main surfaces of the substrate 30 included in the AC adapter 1, are parallel to the z-x plane and that the plug 11, while protruding from a frame 13, protrudes in the positive z-axis direction.

As illustrated in FIG. 1, the AC adapter 1 includes a power supply module 10, the housing 20, and the substrate 30. The power supply module 10 is also an embodiment of the present invention.

The power supply module 10 supplies, to an AC-DC conversion circuit 33 (not illustrated in FIG. 1) via an input port 31 provided on the substrate 30, AC power that has been supplied from an electrical outlet, which is an output port of a commercial AC power supply. The AC-DC conversion circuit 33 converts the supplied AC power into DC power having a predetermined voltage ratio.

In the present embodiment, an output port 32 is a connector jack of USB Type-A in accordance with the Universal Serial Bus (USB) standard. It is therefore possible to connect, to the output port 32, a USB cable having one end part to which a connector plug of USB Type-A is provided. The output port 32 outputs DC power which has been supplied from the AC-DC conversion circuit 33 to, an external terminal to which the output port 32 is connected via a USB cable. The specific structure (such as the connector jack of USB Type-A) of the output port 32 is not illustrated in FIG. 1.

However, the output port 32 is not limited to the connector jack of USB Type-A in accordance with the USB standard, and can be selected as appropriate from commercially available connector jacks according to the applications. Examples of other connector jacks include connector jacks of USB Type-C. When a connector jack of USB Type-C is employed as the output port 32, the AC-DC conversion circuit 33 can be configured in accordance with the USB Power Delivery (PD) standard.

The AC adapter 1 configured as described above is an example of an AC-DC converter, and serves as a charger that charges an external terminal with use of a commercial AC power supply.

The following description will discuss a configuration of the AC adapter 1.

<Power Supply Module>

As illustrated in the exploded perspective view of FIG. 1, the power supply module 10 includes the plug 11, which can be inserted into an electrical outlet, the pair of electrodes 12, and the frame 13. The frame 13 includes a first frame 131 and the second frame 132.

(Plug)

The plug 11 includes the first plug 111 and a second plug 112, and is configured by the first plug 111 and the second plug 112 being a pair. The first plug 111 and the second plug 112 are each a narrow metal plate.

As illustrated in FIG. 4, the first plug 111 and the second plug 112 are joined (fixed) in an electrically insulated manner such that a connecting part 14 prevents the relative positions of the first plug 111 and the second plug 112 from changing. At both end parts of the connecting part 14 in the y-axis direction, respective protrusions 15 each having a columnar shape are formed. The connecting part 14 can be obtained by molding a resin material.

In the present embodiment, the plug 11 is configured as a retractable plug that can protrude from the frame 13 and be stored in the frame 13. It should be noted, however, that the plug 11 can also be configured as a fixed plug that remains protruding from the frame 13. The following description will discuss the power supply module 10 in which the plug 11 is protruding from the frame 13. The plug 11 protrudes from the frame 13 in the positive z-axis direction. The positive z-axis direction is an example of a first direction.

(Pair of Electrodes)

The pair of electrodes 12 includes a first electrode 121 and a second electrode 122. The first electrode 121 and the second electrode 122 are each configured by a narrow metal plate.

As illustrated in FIGS. 4, 5, and 6, the first electrode 121 is obtained by cutting out an L-shaped piece from a metal plate and bending an end part 121a, which is one end part, and a first flat spring 121c, which is the other end part. A part of the first electrode 121c other than the end part 121a and the first flat spring 121c will be referred to as an “intermediate part 121b”. The part corresponding to the corner of the L shape that has been cut out is positioned at the intermediate part 121b.

The second electrode 122 is configured similarly to the first electrode 121. It should be noted, however, that the first plug 111 and the second plug 112 are positioned in the same y-z plane and that the first flat spring 121c and a second flat spring 122c are positioned in a plane P1 described later. In addition, an intermediate part 122b of the second electrode 122 is formed to be smaller than the intermediate part 121b of the first electrode 121 so that the first plug 111 and the first flat spring 121c are electrically communicated via the first electrode 121 and that the second plug 112 and the second flat spring 122c are electrically communicated via the second electrode 122.

The end parts 121a and 122a, each of which is one end part (see FIG. 5), are configured to be electrically communicated with the first plug 111 and the second plug 112, respectively.

FIG. 6 illustrates only the first plug 111 of the plug 11. In FIG. 6, solid lines indicate the first plug 111 of the plug 11 being stored in the frame 13, and imaginary lines indicate the first plug 111 of the plug 11 protruding from the frame 13. Concerning the matters described with reference to FIG. 6, the first plug 111 and the second plug 112 are similarly configured.

As illustrated in FIG. 6, the first electrode 121 is bent such that the angle between the end part 121a and the intermediate part 121b is approximately 135°. At the interface between the end part 121a and the intermediate part 121b, a recess 121d is formed.

While the plug 11 is stored in the frame 13, an end part 111a, which is on the opposite side from the side where the first plug 111 is inserted into an electrical outlet, is spaced from the end part 121a. That is, the first plug 111 and the end part 121a are not electrically communicated.

When the first plug 111 is rotated from the positive x-axis direction to the positive z-axis direction around the center axis of the protrusion 15 in order to cause the plug 11 to protrude from the frame 13, the end part 111a presses the end part 121a, so as to bend part of the end part 121a and the intermediate part 121b. Therefore, because the end part 121a is pressed toward the first plug 111, electrical communication between the first plug 111 and the end part 121a is favorable.

While the plug 11 is protruding from the frame 13 (i.e., while the first plug 111 is protruding in the positive z-axis direction), the end part 111a is fitted into the recess 121d. In this case, because the end part 121a is pressed toward the first plug 111 and because the end part 111a is fitted into the recess 121d, the first plug 111 is fixed by suitable force. In addition, because the end part 111a is fitted into the recess 121d, tactile feedback occurs. This allows the power supply module 10 to let a user know that the plug 11 has protruded from the frame 13.

In addition, the other end parts of the first electrode 121 and the second electrode 122 are each drawn out of the frame 13. The other end parts of the first electrode 121 and the second electrode 122 are configured to be the first flat spring 121c and the second flat spring 122c, respectively, by bending the metal plate. The first flat spring 121c and the second flat spring 122c will be described later with reference to FIGS. 4 and 5.

(Frame)

The frame 13 includes the first frame 131 and the second frame 132. The first frame 131 and the second frame 132 are each obtained by molding a resin material.

The first frame 131, together with the housing described later, serves as an exterior panel of the AC adapter 1. Therefore, the outer surface of the first frame 131 is configured to be smoothly connected with the outer surface of the housing 20. In the outer surface of the first frame 131, a pair of grooves for storing the plug 11 are formed. The inner surface of the first frame 131 (second frame 132-side surface described later) is configured to match the first frame 131-side surface among the surfaces of the second frame 132. By configuring the inner surface of the first frame 131 to match the first frame 131-side surface of the second frame 132, it is possible, when a plurality of types of AC adapters 1 are to be produced, to design the first frame 131 and the substrate 30 as components that are unique to each type of AC adapter 1 and to design the plug 11, the pair of electrodes 12 (the first electrode 121 and the second electrode 122), and the second frame 132 as components that are common to the plurality of types of AC adapters 1. That is, because the plug 11, the first electrode 121, the second electrode 122, and the second frame 132 can be used as a power supply module that is common to the plurality of types of AC adapters 1. This makes it possible to reduce the cost of producing each AC adapter 1 unit.

In the inner side of the first frame 131, a recess is formed so as to substantially correspond to the shape of the outer surface. In the recess, the second frame 132 and the pair of electrodes 12 are provided.

Although the second frame 132 has unevenness formed on main surfaces on both sides, the main part is a plate-like member that is extended two dimensionally. The second frame 132 is fixed to the first frame 131 with use of tow screws (not illustrated in the exploded perspective view of FIG. 1) such that the main part of the second frame 132 corresponds to the x-y plane. Alternatively, the second frame 132 can be fixed to the first frame 131 by a snap-fit system without using screws or the like.

In addition, the following (1) and (2) are formed between the respective surfaces of the first frame 131 and the second frame 132 that face each other: (1) a structure that holds the connecting part 14 and the protrusions 15 so as to be rotatable around the center axis of the protrusions 15; and (2) a structure that fixes the pair of electrodes 12 by sandwiching the intermediate parts 121b and 122b of the first electrode 121 and the second electrode 122 which constitute the pair of electrodes 12. The first frame 131 and the second frame 132 configured as described above sandwich the plug 11 and the pair of electrodes 12 (the first electrode 121 and the second electrode 122) so as to hold the plug 11 and the pair of electrodes 12.

The frame 13, together with the housing 20 described later, stores the substrate 30. In this case, the frame 13 serves as a rear wall that, together with the front wall 25, sandwiches the substrate 30.

(Structure for Holding Substrate)

As illustrated in FIGS. 4 and 5, the first flat spring 121c and the second flat spring 122c are configured by the first regions 121c1 and 122c1, the second regions 121c2 and 122c2, and the third regions 121c3 and 122c3, respectively.

The first regions 121c1 and 122c1, which are parts of the first flat spring 121c and the second flat spring 122c respectively, are drawn out along the plane P1, which is a predetermined plane extending parallel to the z-x plane and are drawn out in the negative z-axis direction. Therefore, the first regions 121c1 and 122c1 are provided substantially in the plane P1. It should be noted that the plane P1 is an example of a plane that extends substantially parallel to (in the present embodiment, parallel to) the positive z-axis direction and is an example of a first plane.

The second frame 132 of the frame 13 is provided with holding parts 132a through 132c that define a plane P2 which extends substantially parallel to the plane P1 and which is spaced from the plane P1 by a predetermined distance D. The plane P2 is an example of a second plane. The holding parts 132a through 132c are each a plate-like protrusion that protrudes in the negative z-axis direction from the surface of the second frame 132 which is provided along the x-y plane. The holding parts 132a through 132c define the plane P2 by their respective lower end parts (end parts toward the positive y-axis direction) forming a plane.

The second regions 121c2 and 122c2 are continuous with the first regions 121c1 and 122c1. The second regions 121c2 and 122c2 are each configured by bending a metal plate so as to become closer to the plane P2 from the plane P1.

The third regions 121c3 and 122c3 are regions which are continuous with the second regions 121c2 and 122c2 and which constitute the ends of the first flat spring 121c and the second flat spring 122c, respectively. The third regions 121c3 and 122c3 are each configured by bending a metal plate so as to become further away from the plane P2.

With the configuration described above, it is possible to sandwich a plate-like member (i.e., substrate 30) of a predetermined thickness between the first flat spring 121c and the second flat spring 122c and the holding parts 132a through 132c.

The thickness of the substrate 30 is less than the distance D and is greater than the minimum value of a distance between the plane P2 and each of the first electrode 121 and the second electrode 122 as illustrated in FIG. 4. This minimum value is a distance between the plane P2 and the vertices of the first electrode 121 and the second electrode 122. The vertex of the first electrode 121 is positioned at the interface between the second region 121c2 and the third region 121c3. The vertex of the second electrode 122 is positioned at the interface between the second region 122c2 and the third region 122c3.

When supports 1311 and 1312 described later are provided on the back surfaces of the first regions 121c1 and 122c1 as in the case of the present embodiment, the thickness of the substrate 30 is preferably less than the distance D by a predetermined amount. The predetermined amount is equal to the thickness (length along the y-axis direction) of the interface regions which are positioned between the first regions 121c1 and 122c1 and the second regions 121c2 and 122c2 and which are bent.

With the above configuration, the substrate 30 can be held by the first flat spring 121c and the second flat spring 122c and the holding parts 132a through 132c.

In other words, it is possible to determine the thickness of the substrate 30 and then, in view of the configuration of each of the first flat spring 121c and the second flat spring 122c, determine the distance D. The distance D can be set as appropriate by adjusting the positions of the holding parts 132a through 132c in the y-axis direction.

The first flat spring 121c and the second flat spring 122c are elastically deformed by a force applied in the direction from the plane P2 to the plane P1 (i.e., force applied along the positive y-axis direction). In addition, the second regions 121c2 and 122c2 are inclined so as to become closer from the plane P1 to the plane P2. Therefore, when the substrate 30 is inserted between the first flat spring 121c and the second flat spring 122c and the holding parts 132a through 132c, the first flat spring 121c and the second flat spring 122c can be elastically deformed without undergoing any issues such as the substrate 30 being stuck.

The first frame 131 of the frame 13 is provided with the supports 1311 and 1312 along the back surfaces of the first regions 121c1 and 122c1 of the first flat spring 121c and the second flat spring 122c, respectively. It should be noted that the back surfaces of the first regions 121c1 and 122c1 are the surfaces on the side opposite from the side facing the second regions 121c2 and 122c2 and the third regions 121c3 and 122c3. In the present embodiment, the supports 1311 and 1312 are configured by a main part that is a plate-like member extending substantially parallel to the z-x plane and by a pair of reinforcement parts which are provided on both sides of the main part and which are each a plate-like member extending substantially parallel to the y-z plane.

The following will supplement the description of the structure of the AC adapter 1 with reference to FIG. 7. (a) and (b) of FIG. 7 are side views illustrating the second frame 132 included in the AC adapter 1. (a) of FIG. 7 illustrates the state in which the substrate 30 is omitted from the state illustrated in (b) of FIG. 7. (c) of FIG. 7 is a side view illustrating the first frame 131 included in the AC adapter 1. (c) of FIG. 7 illustrates the state in which the first frame 131 is added to the state illustrated in (b) of FIG. 7. (a) through (c) of FIG. 7 are obtained by viewing the inside of the AC adapter 1 from the side of the negative y-axis direction in the coordinate system illustrated in FIG. 1. In (b) and (c) of FIG. 7, the first flat spring 121c and the second flat spring 122c which are hidden by the substrate 30 are shown with broken lines. In addition, in (b) and (c) of FIG. 7, the broken lines are used to illustrate: a region where the first flat spring 121c and the first terminal 311 of the input port 31 are electrically communicated; and a region where the second flat spring 122c and the second terminal 312 of the input port 31 are electrically communicated. In (b) and (c) of FIG. 7, the first terminal 311 and the second terminal 312 are omitted because otherwise the first terminal 311 and the second terminal 312 would overlap the first flat spring 121c and the second flat spring 122c and thus viewing would be difficult.

In addition, (a) of FIG. 7 corresponds to a view showing the members in FIG. 4 from another angle. As illustrated in (a) of FIG. 7, the holding parts 132a through 132c are provided at positions which are of the outer surface of the second frame 132 and at which the holding parts 132a through 132c substantially face the first flat spring 121c and the second flat spring 122c. This allows the holding parts 132a through 132c to reliably receive the force that is generated as a result of elastic deformations of the first flat spring 121c and the second flat spring 122c, and therefore makes it possible to stably fix the substrate 30.

(b) of FIG. 7 illustrates the state in which, in the configuration of (a) of FIG. 7, the substrate 30 is sandwiched between the first flat spring 121c and the second flat spring 122c and the holding parts 132a through 132c so as to fix the substrate 30. In the above state, the first flat spring 121c and the first terminal 311 of the input port 31 are electrically communicated, and the second flat spring 122c and the second terminal 312 of the input port 31 are electrically communicated.

(c) of FIG. 7 illustrates the state in which the first frame 131 is attached in the configuration of (b) of FIG. 7. The first frame 131, together with the second frame 132, are storing the plug 11, the intermediate part 121b of the first electrode 121, and the intermediate part 122b of the second electrode 122.

Meanwhile, as described above, the first flat spring 121c and the second flat spring 122c are drawn out of the frame 13 that includes the first frame 131 and the second frame 132. This means that the first flat spring 121c and the second flat spring 122c and the holding parts 132a through 132c sandwich the substrate 30 at a position outside the frame 13. Therefore, as illustrated in (b) and (c) of FIG. 7, the first flat spring 121c and the first terminal 311 are electrically communicated outside the frame 13, and the second flat spring 122c and the second terminal 312 are electrically communicated outside the frame 13. With this configuration, it is possible to (i) correctly insert the substrate 30 in the step of inserting the substrate 30 between the holding part 132a and the first flat spring 121c and between the second flat spring 122c and the holding parts 132b and 132c; and (ii) visually check or capture an image as to whether or not the first flat spring 121c and the second flat spring 122c are electrically communicated with the first terminal 311 and the second terminal 312, respectively. In such a case, it is only necessary to view, from the oblique direction, the main surface 30a, on which the input port 31 is provided, among the pair of main surfaces of the substrate 30 (i.e., the back surface of the substrate 30 illustrated in (b) and (c) of FIG. 7).

In addition, it is possible that the substrate 30, the first frame 131, the housing 20, and the like that are attached to the module which is illustrated in (a) of FIG. 7 and which is a common module including the plug 11, the pair of electrodes 12, and the second frame 132 can be replaced with those of other standards or shapes. In other words, the plug 11, and pair of electrodes 12 (first electrode 121, second electrode 122), and the second frame 132 preferably constitute a power supply module that is common in a case where a plurality of types of AC adapters 1 are produced. When power supply modules each configured by the plug 11, the pair of electrodes 12, and the second frame 132 are made common to a product group of a plurality of types of AC adapters 1, it is possible to produce a product group of desired types of AC adapters 1 by selecting, as appropriate, any one of a plurality of types of substrates 30, any one of a plurality of types of first frames 131, and any one of a plurality of types of housings 20 and then combining the selected ones with a common module. This increases the versatility of the module illustrated in (a) of FIG. 7 so as to mass-produce the modules, and, for example, contributes a reduction in the production cost. In addition, it is possible to mass-produce power supply modules in advance unlike a case where power supply modules configured by the plug 11, the pair of electrodes 12, and the second frame 132 are unique for each model. This makes it possible to also increase production efficiency.

<Housing>

The housing 20 can be obtained by molding a resin material. As illustrated in the exploded perspective view of FIG. 1 and illustrated in FIG. 2, the housing 20 includes bottom walls 21 and 22 which are an example of a pair of bottom walls, side walls 23 and 24 which are an example of a pair of side walls, and the front wall 25.

The outer surfaces of the bottom walls 21 and 22, the side walls 23 and 24, and the front wall 25 are configured to be substantially flat. It should be noted, however, that the center regions of the bottom walls 21 and 22 are configured to bulge out in comparison with the outer peripheral regions. In addition, the interface between the front wall 25 and the side wall 23 and the interface between the front wall 25 and the side wall 24 are each configured to have a round-corner shape so as to be a smooth curved surface.

The bottom walls 21 and 22 extend substantially parallel to the main surfaces 30a and 30b of the substrate 30, and sandwich the substrate 30.

The side walls 23 and 24 and the front wall 25 extend substantially perpendicular to the main surfaces 30a and 30b and surround the three sides of the substrate 30. The side walls 23 and 24 sandwich the substrate 30. The front wall 25 serves with the frame 13 described above to sandwich the substrate 30.

In the present embodiment, the housing 20 and the first frame 131 of the frame 13 are welded to each other while the substrate 30 is stored. It should be noted, however, that the method for joining the housing 20 and the frame 13 is not limited to welding, and can be selected as appropriate.

The substrate 30 is thus sandwiched from the four sides between the housing 20 and the frame 13. The region of the substrate 30 where the input port 31 is formed is held by the first flat spring 121c and the second flat spring 122c and the holding parts 132a through 132c.

In addition, the inner surfaces (inner walls) of the side walls 23 and 24 are provided with slots 231 and 241, which are a pair of slots that are apart by a distance substantially matching the width of the substrate 30 (length along the x-axis direction) and that allows the substrate 30 to move in the positive z-axis direction and the negative z-axis direction (see FIG. 2). In addition, a region R30 indicated with the imaginary lines in FIG. 2 is a region in which the substrate is to be stored. The slots 231 and 241 are grooves that are formed in the inner walls of the side walls 23 and 24. The slots 231 and 241 restrict movements along the directions normal to the main surfaces 30a and 30b of the substrate 30 (i.e., y-axis direction).

As described later, in the present embodiment, the output port 32 is provided in, among the outer peripheral regions of the substrate 30, the outer peripheral region in proximity to the front wall 25. Therefore, an opening 251 is provided in the region corresponding to the output port 32 of the front wall 25.

In the region surrounding the opening 251 of the front wall 25, a guide groove 252 is formed so as to have a thickness that becomes thinner over a certain width. The guide groove 252 is configured so that the outer peripheries of the output port 32 are fitted into the guide groove 252 while the substrate 30 is stored in the housing 20 and the frame 13 is fused. Therefore, the position of the output port 32 is held by the guide groove 252.

In the vicinity of the long sides of the opening 251 that is rectangular, guide claws 253 and 254 extending along the opening 251 are provided. The guide claws 253 and 254 are plate-like members that protrude from the inner walls of the front wall 25 in the positive z-axis direction.

In addition, ribs 255, 256, and 257, which protrude in the form of lines from the inner wall of the bottom wall 21, are formed at the bottom wall 21. In addition, ribs 258, 259, and 260, which protrude in the form of lines from the inner wall of the bottom wall 22, are formed at the bottom wall 22.

In the present embodiment, the three ribs 255 through 257 and the three ribs 258 through 260 are provided at the bottom walls 21 and 22, respectively. It should be noted, however, that the number of the ribs to be formed at each of the bottom walls 21 and 22 is not limited, and can be one or more. The design parameters of the ribs, such as the height, the number, and the like can be set as appropriate in view of, for example, the strength and the heat dissipation performance of the housing 20.

<Substrate>

The substrate 30 is a rigid plate-like member whose main parts are configured by a dielectric. For the substrate 30, a printed circuit board can be employed. The thickness of the substrate 30 is less than the distance D illustrated in FIG. 4 and is greater than the minimum value of a distance between the plane P2 and each of the first electrode 121 and the second electrode 122 in the state illustrated in FIG. 4. When supports 1311 and 1312 described later are provided on the back surfaces of the first regions 121c1 and 122c1 as in the case of the present embodiment, the thickness of the substrate 30 is preferably less than the distance D by a predetermined amount. The predetermined amount is equal to the thickness (length along the y-axis direction) of the interface regions which are positioned between the first regions 121c1 and 122c1 and the second regions 121c2 and 122c2 and which are bent. The thickness of the substrate 30 is not limited, and can be set as appropriate.

The input port 31 is provided on the main surface 30a, which is one of the pair of main surfaces of the substrate 30, and the output port 32 and the AC-DC conversion circuit 33 are provided on the main surface 30b, which is the other main surface (see the exploded perspective view of FIG. 1 and see FIG. 3). The output port 32 is provided in, among the outer peripheral regions of the substrate 30, the outer peripheral region in proximity to the front wall 25, so as to correspond to the position of the opening 251 formed in the housing 20.

In the present embodiment, the AC adapter 1 includes one output port 32. It should be noted, however, that the number of output ports 32 included in the AC adapter 1 is not limited to one, and can be two or more. When the number of the output ports 32 is two or more, it is only necessary that a plurality of openings 251 are formed in the front wall 25 so as to correspond to each output port 32.

In FIG. 1, the AC-DC conversion circuit 33 that is provided on the main surface 30b of the substrate 30 is not illustrated. In addition, in FIG. 3, the specific configuration of the AC-DC conversion circuit 33 is not illustrated, and the region where the AC-DC conversion circuit 33 is provided is indicated with imaginary lines (two-dot chain lines). In the present embodiment, the AC-DC conversion circuit 33 is provided only on the main surface 30b. It should be noted, however, that part of the AC-DC conversion circuit 33 can be provided on the main surface 30a.

At part of the outer periphery of the main surface 30a, an input port that inputs AC power into the AC-DC conversion circuit 33 is provided (see the exploded perspective view of FIG. 1 and see FIG. 3).

As described above, as a result of the substrate 30 being inserted between the first flat spring 121c and the second flat spring 122c and the holding parts 132a through 132c, the substrate 30 is held by the first flat spring 121c and the second flat spring 122c and the holding parts 132a through 132c. In this case, as a result of the main surface 30a being biased by the first flat spring 121c and the second flat spring 122c, the main surface 30b substantially matches the plane P2.

In addition, the first flat spring 121c is pressed toward the first terminal 311 of the input port 31, and the second flat spring 122c is pressed toward the second terminal 312 of the input port 31. This causes AC power to be supplied from the pair of electrodes 12 to the input port 31.

As described above, the AC-DC conversion circuit 33 converts the supplied AC power into DC power having a predetermined voltage ratio. Then, the AC-DC conversion circuit 33 supplies the DC power to the output port 32. In the present embodiment, the rated output of the AC-DC conversion circuit 33 is 10.5 W. It should be noted, however, that the rated output of the AC-DC conversion circuit 33 is not limited, and can be set as appropriate according to desired specifications. When a connector jack of USB Type-A is employed as the output port 32, an example of the rated output is 17 W. Alternatively, a connector jack of USB Type-C can be employed as the output port 32, and the AC adapter 1 can be an AC adapter in accordance with the standard of the USB PD.

<Joint Part Between Frame and Housing>

As described above, the housing 20 and the first frame 131 of the frame 13 are joined. Although the method for joining the housing 20 and the first frame 131 is not limited, welding is employed in the present embodiment. With reference to FIG. 1 and (a) of FIG. 8, a joint part 1_{J} at which the housing 20 and the first frame 131 of the AC adapter 1 are joined will be described. In addition, with reference to (b) of FIG. 8, a joint part 1_{Ja} at which a housing 20a and a first frame 131a of an AC adapter 1a, which is a variation of the AC adapter 1, are joined will be described.

The housing 20, in order to store the substrate 30 therein, has an open region that faces the front wall 25. Therefore, in the housing 20, the region facing the front wall (i.e., the end surface in the positive z-axis direction) is provided with an opening (see FIG. 1).

Because the first frame 131 of the frame 13 serves with the housing 20 to store the substrate 30, the first frame 131 serves as a lid with respect to the opening of the housing 20. Therefore, in the first frame 131 also, the region to be abut on the opening of the housing 20 (i.e., the end surface in the negative z-axis direction) has an opening. That is, in the first frame 131, the region to be abut on the opening of the housing 20 (i.e., the end surface in the negative z-axis direction) has an opening formed in such a manner as to have a shape corresponding to the opening of the housing 20.

In the AC adapter 1, the joint part 1_{J} is formed as a result of the opening of the housing 20 and the opening of the first frame 131, which are molded into shapes corresponding to each other, abutting on each other (see (a) of FIG. 8).

In the present embodiment, ribs 131j protrude in the negative z-axis direction along the inner periphery of the opening of the first frame 131, and ribs 21j protrude in the positive z-axis direction along the outer periphery of the opening of the housing 20. In other words, the opening of the first frame 131 is molded in a stepped shape such that the region along the inner periphery is protruding, and the opening of the housing 20 is molded in a stepped shape such that the region along the outer periphery is protruding.

As a result of configuring the respective openings of the first frame 131 and the housing 20, the ribs 131_{J} and the ribs 21_{J} engage when the opening of the first frame 131 and the opening of the housing 20 abut on each other. It is therefore possible to suppress possible misalignment of the first frame 131 and the housing 20 when the opening of the first frame 131 and the opening of the housing 20 abut on each other.

It should be noted, however, that when the joining is performed at the joint part 1_{J} (welding in the present embodiment), the misalignment between the first frame 131 and the housing 20 may occur, depending on the manner in which the opening of the first frame 131 and the opening of the housing 20 abut on each other. This is because the opening of the first frame 131 may receive the force so as to be deformed inwardly, and the opening of the housing 20 may receive the force so as to be deformed outwardly.

In the AC adapter 1a illustrated in (b) of FIG. 8, the ribs 131_{Ja} are moved from the position along the inner periphery of the opening of the first frame 131 to the position that is the midpoint between the inner periphery and the outer periphery. Therefore, in the opening of the first frame 131, the region along the inner periphery and the region along the outer periphery are depressed, and the region at the midpoint between the inner periphery and the outer periphery is protruding.

In the opening of the housing 20a, grooves 21_{Ja} are formed at the position that is the midpoint between the inner periphery and the outer periphery, so as to correspond to the shape of the ribs 131_{Ja} of the first frame 131a.

As a result of configuring the respective openings of the first frame 131a and the housing 20a, the ribs 131 Ja and the grooves 21_{Ja} engage when the opening of the first frame 131a and the opening of the housing 20a abut on each other. Therefore, at the joint part 1_{Ja}, the force to deform the opening of the first frame 131a inwardly or outwardly is unlikely to occur, and the force to deform the opening of the housing 20a inwardly or outwardly is unlikely to occur. In the AC adapter 1a, it is thus possible to suppress the misalignment of the first frame 131 and the housing 20 that may occur when the joining is performed at the joint part 1_{Ja}.

<Effects of Power Supply Module and AC Adapter>

As described above, in the power supply module 10, the other end parts of the first electrode 121 and the second electrode 122 constituting the pair of electrodes 12 are respectively configured by the first flat spring 121c and the second flat spring 122c that are drawn out of the frame 13.

With the above configuration, it is possible to utilize the elasticity of the first flat spring 121c and the second flat spring 122c when the pair of electrodes 12 and the input port 31 are electrically communicated in the AC adapter 1 including the power supply module 10. That is, it is possible to cause the pair of electrodes 12 and the input port 31 to suitably come into contact with each other without using an electric communication means such as solder or screws. Therefore, the power supply module 10 can simplify the step of causing the pair of electrodes 12 and the input port 31 to be electrically communicated.

In the power supply module 10, the first flat spring 121c and the second flat spring 122c are each drawn out along the plane P1 in the negative z-axis direction, and the second frame 132 of the frame 13 is provided with the holding parts 132a, 132b, and 132c that define the plane P2 which extends substantially parallel to the plane P1 and which is spaced from the plane P1 by the distance D that is a predetermined distance. The first flat spring 121c and the second flat spring 122c are each elastically deformed by a force applied in the direction from the plane P2 toward the plane P1.

With the above configuration, the substrate 30 can be joined to the power supply module 10 by inserting the substrate 30 between (i) the first flat spring 121c and the second flat spring 122c and (ii) the holding parts 132a, 132b, and 132c. The pair of electrodes 12 and the input port 31 can be electrically communicated merely by inserting the substrate 30 on which the input port 31 is formed, between (i) the first flat spring 121c and the second flat spring 122c and (ii) the holding parts 132a, 132b, and 132c. Therefore, the power supply module 10 can further simplify the step of causing the pair of electrodes 12 and the input port 31 to be electrically communicated.

The frame 13 is provided with the holding parts 132a through 132c that fix the substrate 30 by sandwiching the substrate 30 between the holding parts 132a through 132c and the first flat spring 121c and the second flat spring 122c at the position outside the frame 13. When the substrate 30 is sandwiched outside the frame 13 between the first flat spring 121c and the second flat spring 122c and the holding parts 132a through 132c, the pair of electrodes 12 (the first flat spring 121c and the second flat spring 122c) and the input port 31 are electrically communicated outside the frame 13. This configuration brings about effects below.

(1) In the parts other than the parts where the first flat spring 121c and the second flat spring 122c are drawn out, the frame 13 covers the plug 11, the first electrode 121, and the second electrode 122 so as to fix and protect the plug 11, the first electrode 121, and the second electrode 122. This allows the frame 13, which stores the plug 11, the first electrode 121, and the second electrode 122, to be easily produced, transported, and sold as a partial module of the AC adapter 1.

(2) In the case where the frame 13 covers the plug 11, the first electrode 121, and the second electrode 122 in (1) above, causing each flat spring and the input port to be electrically communicated does not require taking the frame 13 apart so as to expose the first electrode 121 and the second electrode 122.

(3) The frame 13 itself can be made compact by fixing the substrate 30 outside the frame 13 without storing the substrate 30 in the frame 13.

(4) It is easy to confirm, by visually checking or using an image, that the first terminal 311 and the first flat spring 121c are electrically communicated outside the frame 13 and that the second terminal 312 and the second flat spring 122c are electrically communicated outside the frame 13.

In the power supply module 10, the first flat spring 121c and the second flat spring 122 include the first regions 121c1 and 122c1 respectively, and the second frame 132 is further provided with the supports 1311 and 1312 that are provided along the back surfaces of the first regions 121c1 and 122c1.

According to the configuration, the second frame 132 is further provided with the supports 1311 and 1312. This prevents the first flat spring 121c and the second flat spring 122c from being excessively bent when the substrate is inserted between (i) the first flat spring 121c and the second flat spring 122c and (ii) the holding parts 132a, 132b, and 132c. Therefore, the first flat spring 121c and the second flat spring 122c can each be pressed firmly by the input port 31.

The frame 13 includes the first frame 131 and the second frame 132. The plug 11, the pair of electrodes 12 (first electrode 121, second electrode 122), and the second frame 132 can be configured as a power supply module to which a plurality of types of substrates 30 or first frames 131 can be attached. This power supply module is common to AC adapters of a plurality of models.

With the configuration, it is possible to increase the versatility of the power supply module so as to mass-produce the power supply module. It is therefore possible to, for example, reduce the cost of the AC adapters. In addition, it is possible to mass-produce power supply modules in advance unlike a case where power supply modules configured by the plug 11, the pair of electrodes 12, and the second frame 132 are unique for each model. This makes it possible to also increase production efficiency.

The AC adapter 1 includes the power supply module 10, the housing 20, the substrate 30, the output port 32, and the AC-DC conversion circuit 33.

A power supply module in accordance with an aspect of the present invention can be thus suitably used for AC adapters.

In the AC adapter 1, the input port 31 is provided at part of the outer periphery of the main surface 30a of the substrate 30, and the substrate 30 is held by the first flat spring 121c and the second flat spring 122c and the holding parts 132a, 132b, and 132c such that (i) the main surface 30b substantially matches the plane P2 and (ii) the input port 31 is biased by the first flat spring 121c and the second flat spring 122c.

With the above configuration, the pair of electrodes 12 and the input port 31 can be electrically communicated merely by inserting the substrate 30 on which the input port 31 is formed, between (i) the first flat spring 121c and the second flat spring 122c and (ii) the holding parts 132a, 132b, and 132c. The step of producing the AC adapter 1 can be simplified.

In the AC adapter 1, the housing 20 includes (1) the pair of bottom walls 21 and 22 which sandwich the substrate and (2) the pair of side walls 23 and 24 and the front wall 25 which surround the substrate 30 from the three sides. The frame 13 serves as a rear wall that, together with the front wall 25, sandwiches the substrate 30. The side walls 23 and 24 are provided with the pair of slots 231 and 241.

According to the above configuration, (i) the side walls 23 and 24 restrict a movement along the width direction (x-axis direction) of the substrate 30, (ii) the front wall 25 and the frame 13 restrict a movement along the direction (z-axis direction) orthogonal to the width direction of the substrate 30, and (iii) the slots 231 and 241 restrict a movement along the direction (y-axis direction) normal to the substrate 30. That is, the substrate can be fixed in the housing without using a fixing means such as an adhesive or screws. Therefore, the step of producing the AC adapter 1 can be further simplified.

In the AC adapter 1, the output port 32 is provided in, among the outer peripheral region of the substrate 30, the outer peripheral region in proximity to the front wall 25, and the opening 251 is provided in the region corresponding to the output port 32 of the front wall 25.

With the above configuration, the output port 32 can be exposed from the opening 251 merely by molding the components of the housing 20 together and then moving the substrate 30 along the slots 231 and 241. The step of producing the AC adapter 1 can be further simplified.

In the AC adapter 1, the ribs 255 through 260 are formed at the bottom walls 21 and 22.

With the above configuration, it is possible to provide a space corresponding at least to the height of the ribs 255 through 260, between (i) the substrate 30 and the AC-DC conversion circuit 33 which are stored in the housing 20 and (ii) the bottom walls 21 and 22. Even when a pressure in the direction to collapse the housing is applied to the bottom walls 21 and 22, it is possible to prevent the direct contact of (i) the substrate 30 and the AC-DC conversion circuit 33 and (ii) the bottom walls 21 and 22. The AC adapter 1 can have improved resistance to heat which results from the AC-DC conversion circuit 33.

### Embodiment 2

<Product Group of AC Adapters>

The following description will discuss an AC adapter product group in accordance with Embodiment 2 of the present invention, with reference to FIGS. 9 and 10. The AC adapter product group in accordance with the present embodiment are constituted by AC adapters 1, 1A, 1B, 1C, 1D, 1E, and 1F of a plurality of models (seven models in the present embodiment). It should be noted, however, that the number of models of the AC adapters constituting the present product group is not limited to seven, and can be set as appropriate, provided that the number is two or more. The number of models can be increased or decreased as appropriate.

(a) of FIG. 9 is a plan view of the AC adapter 1 in which an opening 251 provided in a housing 20 is viewed in a plan view, and (e) of FIG. 9 is a perspective view of the AC adapter 1. (b) of FIG. 9 is a plan view of the AC adapter 1A in which an opening 251A1 and an opening 251A2 that are provided in a housing 20 are viewed in a plan view, and (f) of FIG. 9 is a perspective view of the AC adapter 1A. (c) of FIG. 9 is a plan view of the AC adapter 1B in which an opening 251B provided in a housing 20B is viewed in a plan view, and (g) of FIG. 9 is a perspective view of the AC adapter 1B. (d) of FIG. 9 is a plan view of an AC adapter 1C in which an opening 251C provided in a housing 20C is viewed in a plan view. (h) of FIG. 9 is a perspective view of the AC adapter 1C.

(a) of FIG. 10 is a plan view of an AC adapter 1D in which an opening 251D1 and an opening 251D2 provided in a housing 20D are viewed in a plan view, and (d) of FIG. 9 is a perspective view of the AC adapter 1D. (b) of FIG. 10 is a plan view of an AC adapter 1E in which an opening 251E1 and an opening 251E2 provided in a housing 20E are viewed in a plan view, and (e) of FIG. 9 is a perspective view of the AC adapter 1E. (c) of FIG. 10 is a plan view of an AC adapter 1F in which an opening 251F provided in a housing 20F is viewed in a plan view. (f) of FIG. 9 is a perspective view of the AC adapter 1F.

The AC adapters 1, 1A, 1B, 1C, 1D, 1E, and 1F of the seven models are common in terms of each being an AC adapter that converts AC power supplied from an electrical outlet into DC power, and each include a power supply module configured by a plug 11, a pair of electrodes 12, and a second frame 132. The second frame 132 is an example of the internal frame in the Claims.

It should be noted, however, that the AC adapters 1, 1A, 1B, 1C, 1D, 1E, and 1F of the seven models are differentiated as different models in that these AC adapters differ in (i) the rated output of the AC-DC conversion circuit 33, (ii) the shape of an output port 32 that outputs post-conversion DC power (in other words, the standard to which the output port 32 conforms), and (iii) the number of output ports 32 that output post-conversion DC power. The AC adapters 1, 1A, 1B, 1C, 1D, 1E, and 1F of the seven models each include, as a configuration for the differentiation of the models, (i) any of the first frames 131, 131A, 131B, 131C, 131D, 131E, and 131F, (ii) any of the housings 20, 20A, 20B, 20C, 20D, 20E, and 20F, (iii) any of the substrates 30, 30A, 30B, 30C, 30D, 30E, and 30F, (iv) the output port 32, and (v) the AC-DC conversion circuit 33.

The present embodiment will discuss the power supply module which is configured to be common to each model and the first frames 131, 131A, 131B, 131C, 131D, 131E, and 131F, the housings 20, 20A, 20B, 20C, 20D, 20E, and 20F, the substrates 30, 30A, 30B, 30C, 30D, 30E, and 30F, the output port 32, and the AC-DC conversion circuit 33 which are configured to be unique to each model. The first frames 131, 131A, 131B, 131C, 131D, 131E, and 131F and the housings 20, 20A, 20B, 20C, 20D, 20E, and 20F together constitute the housings in the Claims.

The AC adapter 1 is configured to be identical to the AC adapter 1 described in Embodiment 1. That is, in the AC adapter 1, the rated output of the AC-DC conversion circuit 33 is set to 10.5 W, and a connector jack of USB Type-A is employed as an output port 32. That is, the shape of the opening 251 provided in the housing 20 corresponds to the shape of the connector jack of USB Type-A (see (a) and (e) of FIG. 9). The first frame 131, which serves with the housing to constitute the housing in the Claims, is molded so as to correspond to the shape and the size of the housing 20.

In the AC adapter 1A, the rated output of the AC-DC conversion circuit 33 is set to 17 W, and two connector jacks of USB Type-A are employed as output ports 32. That is, in the housing 20A, two opening 251A1 and 251A2 are provided so as to correspond to the two connector jacks, and the shape of each of the opening 251A1 and 251A2 corresponds to the shape of the connector jack of USB Type-A (see (b) and (f) of FIG. 9). A first frame 131A, which serves together with the housing 20A to constitute the housing in the Claims, is molded so as to correspond to the shape and the size of the housing 20A.

In the AC adapter 1B, the rated output of the AC-DC conversion circuit 33 is set to 20 W, and a connector jack of USB Type-C are employed as an output port 32. That is, the shape of the opening 251B provided in the housing 20B corresponds to the shape of the connector jack of USB Type-C (see (c) and (g) of FIG. 9). The AC adapter 1B is in accordance with the power supply standard called USB Power Delivery (PD). A first frame 131B, which serves with the housing 20B to constitute the housing in the Claims, is molded so as to correspond to the shape and the size of the housing 20B.

In the AC adapter 1C, the rated output of the AC-DC conversion circuit 33 is set to 30 W, and a connector jack of USB Type-C is employed as an output port 32. That is, the shape of the opening 251C provided in the housing 20C corresponds to the shape of the connector jack of USB Type-C (see (d) and (h) of FIG. 9). The AC adapter 1C is in accordance with the power supply standard called USB Power Delivery (PD). A first frame 131C, which serves together with the housing 20C to constitute the housing in the Claims, is molded so as to correspond to the shape and the size of the housing 20C.

In the AC adapter 1D, the rated output of the AC-DC conversion circuit 33 is set to 27 W, and a connector jack of USB Type-A and a connector jack of USB Type-C are employed as output ports 32. That is, the shape of the opening 251D1 provided in the housing 20D corresponds to the shape of the connector jack of USB Type-A, and the shape of the opening 251D2 provided in the housing 20D corresponds to the shape of the connector jack of USB Type-C (see (a) and (d) of FIG. 10). A first frame 131D, which serves with the housing 20D to constitute the housing in the Claims, is molded so as to correspond to the shape and the size of the housing 20D. The AC adapter 1D is in accordance with the power supply standard called USB Power Delivery (PD).

In the AC adapter 1E, the rated output of the AC-DC conversion circuit 33 is set to 32 W, and a connector jack of USB Type-A and a connector jack of USB Type-C are employed as output ports 32 (see (b) and (e) of FIG. 10). The

AC adapter 1E differs from the AC adapter 1D only in that the rated output of the AC-DC conversion circuit 33 is 32 W. That is, between the AC adapter 1E and the AC adapter 1D, (i) the AC-DC conversion circuit 33s are components unique to their respective adapters, (ii) the housing 20E and the housing 20D are common components having the identical shape, and (iii) the first frame 131E and the first frame 131D are common components having the identical shape. In some of the AC adapters constituting the AC adapter product group, it is possible to use any of the substrates, the first frames, and the housings as common components. A first frame 131E, which serves with the housing 20E to constitute the housing in the Claims, is molded so as to correspond to the shape and the size of the housing 20E. The AC adapter 1E is in accordance with the power supply standard called USB Power Delivery (PD).

In the AC adapter 1F, the rated output of the AC-DC conversion circuit 33 is set to 15 W, and a connector jack of USB Type-C is employed as an output port 32 (see (c) and (f) of FIG. 10). The AC adapter 1F differs from the AC adapter 1B only in that the rated output of the AC-DC conversion circuit 33 is 15 W. That is, between the AC adapter 1F and the AC adapter 1B, (i) the AC-DC conversion circuit 33s are components unique to their respective adapters, (ii) the housing 20F and the housing 20B are common components having the identical shape, and (iii) the first frame 131F and the first frame 131B are common components having the identical shape. In some of the AC adapters constituting the AC adapter product group, it is possible to use any of the substrates, the first frames, and the housings as common components. A first frame 131F, which serves with the housing 20F to constitute the housing in the Claims, is molded so as to correspond to the shape and the size of the housing 20F. The AC adapter 1F is in accordance with the power supply standard called USB Power Delivery (PD).

[Effects of Product Group of AC Adapters]

As described above, the AC adapter product group in accordance with the present embodiment are constituted by AC adapters 1, 1A, 1B, 1C, 1D, 1E, and 1F of a plurality of models (seven models in the present embodiment). The AC adapters 1, 1A, 1B, 1C, 1D, 1E, and 1F of the respective models each include the power supply module and the housing 20. The power supply module includes (1) the plug 11 which is constituted by a first plug 111 and a second plug 112, (2) a pair of electrodes 12 each of which is constituted by a metal plate and which are constituted by a first electrode 121 and a second electrode 122 that have respective one end parts configured to be electrically communicated with a first plug 111 and a second plug 112, respectively, and (3) an internal frame (second frame 132) which attaches the plug 11 and the pair of electrodes 12 to the housing 20. The first frames 131, 131A, 131B, 131C, 131D, 131E, and 131F constituting parts of the housings 20, 20A, 20B, 20C, 20D, 20E, and 20F are each configured to serve with the internal frame (second frame 132) to sandwich the plug 11 and the pair of electrodes 12. The power supply module is a component that is common to the AC adapters 1, 1A, 1B, 1C, 1D, 1E, and 1F. Meanwhile, the housing 20 is unique to each of the AC adapters 1, 1A, 1B, 1C, 1D, 1E, and 1F.

The present product group thus includes the power supply module as a component that is common to the AC adapters 1, 1A, 1B, 1C, 1D, 1E, and 1F. The number of components used in producing the product group can be reduced even when the number of models of AC adapters constituting the product group is increased due to a combination of the standard of the connector jacks constituting the output ports 32, the number of output ports 32, and the rated output of the AC-DC conversion circuit 33. In addition, the fact that the common power supply module is standardized means that it is possible to standardize the attachment step of attaching the power supply module to the inner wall of the second frame 132 that constitutes part of the housing. Therefore, the present product group can reduce the cost in producing AC adapters of a plurality of models. In addition, it is possible to mass-produce power supply modules in advance unlike a case where power supply modules configured by the plug 11, the pair of electrodes 12, and the second frame 132 are unique for each model. This makes it possible to also increase production efficiency.

<Method for Producing AC Adapter Product Group>

The following description will discuss a method for producing the AC adapters 1, 1A, 1B, 1C, 1D, 1E, and 1F that constitute the AC adapter product group in accordance with Embodiment 2. The present production method is also included in the scope of the present invention.

As described above, the AC adapters 1, 1A, 1B, 1C, 1D, 1E, and 1F which are AC adapters of a plurality of models each include the power supply module that is common to all the models. The power supply modules each include (1) the plug 11 which is constituted by a first plug 111 and a second plug 112, (2) a pair of electrodes 12 each of which is constituted by a metal plate and which are constituted by a first electrode 121 and a second electrode 122 that have respective one end parts configured to be electrically communicated with a first plug 111 and a second plug 112, respectively, and (3) an internal frame (second frame 132) which attaches the plug 11 and the pair of electrodes 12 to any of the first frames 131, 131A, 131B, 131C, 131D, 131E, and 131F constituting parts of the housings 20, 20A, 20B, 20C, 20D, 20E, and 20F. In addition, the power supply module is common to the AC adapters 1, 1A, 1B, 1C, 1D, 1E, and 1F.

The first frames 131, 131A, 131B, 131C, 131D, 131E, and 131F constituting parts of the housings 20, 20A, 20B, 20C, 20D, 20E, and 20F are each configured to serve with the internal frame (second frame 132) to sandwich the plug 11 and the pair of electrodes 12. In addition, the first frames 131, 131A, 131B, 131C, 131D, 131E, and 131F and the housings 20, 20A, 20B, 20C, 20D, 20E, and 20F which constitute the housings are respectively unique to the AC adapters 1, 1A, 1B, 1C, 1D, 1E, and 1F of the plurality of models.

The present production method includes: a housing selection step of selecting a specific housing (such as the first frame 131 and the housing 20) from the first frames 131, 131A, 131B, 131C, 131D, 131E, and 131F and the housings 20, 20A, 20B, 20C, 20D, 20E, and 20F which constitute a plurality of types of housings; and the attachment step of attaching the power supply module to the inner wall of the specific housing (such as the first frame 131 and the housing 20).

In addition, the present production method further includes a substrate selection step, a substrate attachment step, a substrate storing step, and a welding step.

In the present product group, the substrates 30, 30A, 30B, 30C, 30D, 30E, and 30F are each provided with the output port 32 and the AC-DC conversion circuit 33 which are unique to each of the AC adapters 1, 1A, 1B, 1C, 1D, 1E, and 1F of the plurality of models (see the exploded perspective view of FIG. 1 and see FIG. 3). The substrate selection step is a step of selecting a specific substrate from the plurality of types of substrates 30, 30A, 30B, 30C, 30D, 30E, and 30F.

The substrate attachment step is a step of sandwiching the input port 31 of the substrate selected in the substrate selection step between the pair of electrodes 12 and the holding parts 132a, 132b, and 132c, so as to cause the first electrode 121 and the first terminal 311 to be electrically communicated and cause the second electrode 122 and the second terminal 312 to be electrically communicated. That is, the substrate attachment step is a step of attaching the substrate to the frame 13.

The substrate storing step is a step of sliding the substrate attached to the frame 13 into the pair of slots 231 and 241 of the housing selected in the housing selection step, so as to store the substrate in the inner space of the housing and the first frame 131.

The welding step is a step of performing welding at the joint part 1_{J} while causing the opening of the first frame 131 and the opening of the housing to abut on each other.

For example, when the present production method is used to produce an AC adapter 1, in the housing selection step, a first frame 131 is selected from first frames 131, 131A, 131B, 131C, 131D, 131E, and 131F, and a housing 20 is selected from housings 20, 20A, 20B, 20C, 20D, 20E, and 20F. In the attachment step, a power supply module including a plug 11, a pair of electrodes 12, and a second frame 132 is attached to the inner wall of the first frame 131 that constitutes part of the housing. In the substrate selection step, a substrate 30 is selected from substrates 30, 30A, 30B, 30C, 30D, 30E, and 30F. In the substrate attachment step, the substrate 30 is attached to the frame 13. In the substrate storing step, the substrate 30 is stored in the inner space of the housing that is constituted by the housing 20 and the first frame 131. In the welding step, welding is performed at the joint part 1_{J} while causing the opening of the first frame 131 and the opening of the housing 20 to abut on each other.

As described above, in the present production method, the first frames 131, 131A, 131B, 131C, 131D, 131E, and 131F, the housings 20, 20A, 20B, 20C, 20D, 20E, and 20F, and the substrates 30, 30A, 30B, 30C, 30D, 30E, and 30F are each a component that is unique to each model, while the power supply module is a component that is common to the AC adapters 1, 1A, 1B, 1C, 1D, 1E, and 1F.

As described above with reference to FIGS. 9 and 10, the AC adapter 1D and the AC adapter 1E use the first frame 131D and the housing 20D (or the first frame 131E and the housing 20E) as common components, and the AC adapter 1B and the AC adapter 1F use the first frame 131B and the housing 20B (or the first frame 131F and the housing 20F) as common components. The number of housings of the plurality of types (which is five in the present embodiment) can be thus less than the number of models of the AC adapters that constitute a product group (which is seven in the present embodiment).

[Effects of Production Method]

As described above, a production method in accordance with the present embodiment is a method for producing a plurality of models of AC adapters by using power supply modules and a plurality of types of housings that store the power supply modules. The plurality of types of housings are constituted by first frames 131, 131A, 131B, 131C, 131D, 131E, and 131F and housings 20, 20A, 20B, 20C, 20D, 20E, and 20F. In an AC adapter of each model, (i) the power supply module includes (1) the plug 11 which is constituted by a first plug 111 and a second plug 112, (2) a pair of electrodes 12 each of which is constituted by a metal plate and which are constituted by a first electrode 121 and a second electrode 122 that have respective one end parts configured to be electrically communicated with a first plug 111 and a second plug 112, respectively, and (3) an internal frame (second frame 132) which attaches the plug 11 and the pair of electrodes 12 to the housing 20 and (ii) the power supply module is common to the plurality of models. In addition, in the power supply module, any one of the first frames 131, 131A, 131B, 131C, 131D, 131E, and 131F and any one of the housings 20, 20A, 20B, 20C, 20D, 20E, and 20F, which constitute the housing, are configured to serve with the internal frame (second frame 132) to sandwich the plug 11 and the pair of electrodes 12, and are unique to each of the plurality of models.

In addition, the present production method includes: the housing selection step of selecting a specific housing (such as the first frame 131 and the housing 20) from the plurality of types of housings (such as the first frames 131, 131A, 131B, 131C, 131D, 131E, and 131F and the housings 20, 20A, 20B, 20C, 20D, 20E, and 20F); and the attachment step of attaching the power supply module to the inner wall of the first frame (such as the first frame 131) that constitutes part of the specific housing.

The present production method including these features, as in the case of the above-described product group, can reduce the cost in producing AC adapters of a plurality of models, and improve production efficiency.

### Additional Remarks

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 AC adapter
10 Power supply module
11 Plug
111, 112 First plug, second plug
12 Pair of electrodes
121, 122 First electrode, second electrode
121a, 122a End part (one end part)
121c, 122c First flat spring, second flat spring (other end part)
121c1, 122c1 First region
60-121c2, 122c2 Second region
121c3, 122c3 Third region
13 Frame (rear wall)
131 First frame (serving with housing 20 to constitute housing in claims
132 Second frame (internal frame)
132a, 132b, 132c Holding part
20 Housing (serving with first frame 131 to constitute housing in claims
21, 22 Bottom wall (pair of bottom walls)
23, 24 Side wall (pair of side walls)
231, 241 Slot (pair of slots)
Front wall (front wall)
251 Opening
255 through 266 Rib (pair of ribs)
30 Substrate
30a, 30b Main surface (one main surface, other main surface)
31 Input port
311, 312 First terminal, second terminal
32 Output port
33 AC-DC conversion circuit

1-2. (canceled)

3. A power supply module, comprising:
a plug, including a pair of a first plug and a second plug which are each a narrow metal plate, the first plug and the second plug having respective one end parts which are able to be inserted into an electrical outlet;
a connecting part, provided near respective other end parts of the first plug and the second plug, and connecting the first plug and the second plug while electrically insulating the first plug and the second plug;
a first electrode and a second electrode, each configured by a metal plate, and having respective one end parts which are electrically communicated with the respective other end parts of the first plug and the second plug; and
a frame, holding the connecting part, the first electrode, and the second electrode,
the connecting part being rotatable to switch between a state where the plug is contained in the frame and a state the plug protrudes from the frame,
the first electrode and the second electrode each further having, in addition to the respective one end parts, (i) respective other end parts and (ii) respective intermediate parts positioned between the respective one end parts and the respective other end parts,
the respective intermediate parts of the first electrode and the second electrode being positioned to be along the plug in the state where the plug is stored in the frame,
when switching from the state where the plug protrudes from the frame to the state where the plug is contained in the frame, the connecting part rotating in a direction in which the plug is closer to the respective intermediate parts of the first electrode and the second electrode,
the respective one end parts of the first electrode and the second electrode being bended, at interfaces between the respective one end parts and the respective intermediate parts of the first electrode and the second electrode, so as to be closer to the plug.

4. The power supply module as set forth in claim 3, wherein at the interfaces between the respective one end parts and the respective intermediate parts of the first electrode and the second electrode, respective recesses are formed, into which the respective other end parts of the first plug and the second plug are fitted in the state where the plug protrudes from the frame.

5. An AC adapter, comprising:
a power supply module as set forth in claim 3;
a substrate on which an AC-DC conversion circuit is mounted;
an output port for outputting a DC power supplied from the AC/DC conversion circuit; and
a housing containing the substrate, the AC-DC conversion circuit, and the output port.
